(19) United States
(12) Patent Application Publication
(10) Pub. No.: US 2008/0309443 A1
(43) Pub. Date: Dec. 18, 2008

(54) INDUCTOR AND METHOD FOR PRODUCING IT

(75) Inventor: Masahiro FURUYA, Yamanashi (JP)

Correspondence Address: BROWDY AND NEIMARK, P.L.L.C.;624 NINTH STREET, NW, SUITE 300, WASHINGTON, DC, 20001-5303, US

(73) Assignee: CITIZEN ELECTRONICS CO., LTD., Fujiyoshida-shi (JP)

(21) Appl. No.: 12/135,825

(22) Filed: Jun. 9, 2008

(30) Foreign Application Priority Data
Jun. 8, 2007 (JP) 2007-152405

(51) Int. Cl. H01F 27/02

(52) U.S. Cl. 336/83; 29/606

(57) ABSTRACT

An inductor includes a coil formed by winding a metallic wire, terminal electrodes connected to the coil, a first resin which is configured to cover at least one portion of a peripheral side surface of the coil and contains a magnetic powder, and a second resin which does not contain the magnetic powder and is configured to seal the coil covered by the first resin. Thereby, it is possible to provide an inductor having a stable characteristic with an unchanging L value even when there is contact during mounting of the inductor or impact during use of an electronic device in which the inductor is installed.

### CROSS-REFERENCE TO THE RELATED APPLICATION

This application is based on and claims priority under 35 U.S.C, §119 to Japanese Patent Application No. 2007-152405, filed on Jun. 8, 2007, the disclosure of which is incorporated herein by reference in its entirety.

### BACKGROUND OF THE INVENTION

1. Field of the Invention

The present invention relates to an inductor used for an electronic circuit and a method for producing it.

2. Description of the Related Art

A DC/DC converter which is a supply voltage converting circuit is conventionally used for a power supply device, various drive circuits used in, for example, mobile electronic devices such as a mobile phone, a digital camera or the like. Extension of battery life through limiting of the power consumption is a requirement of the DC/DC converter. Therefore, a large number of non-insulative chopper systems having high voltage-conversion efficiency have been adopted. In these systems, an inductor is important as a key device having a great influence on the voltage-conversion efficiency.

Accordingly, it is required for an inductor mounted on a mobile electronic device to have high performance enabling a large current flow, a compact size, a thinned shape, and large inductance. Responding to the requirements, there is known a conventional inductor in which a coil is formed by winding a metallic wire on a bobbin made of a magnetic material such as ferrite material or the like, and in which an outer peripheral surface of the coil is sealed by a resin containing ferrite powder (for reference, see Japanese Patent Laid-Open No.11-121244, p 2 of the specification and FIG. 3).

FIG. 14 illustrates one example of the conventional inductor. The inductor 60 has a structure including a coil 63 which is composed of a bobbin 61 and a metallic wire 62 wound on the bobbin 61 and an armoring material 64 configured to seal the coil 63. Terminal electrodes 65a and 65b configured to be electrically connected to an exterior device are exposed from the armoring material 64. The armoring material 64 comprises a ferrite-containing resin containing, for example, ferrite powder at a predetermined rate.

By includining ferrite powder in the armoring material 64, it is possible to enhance the heat dissipation property of the inductor 60, so that heat generated in the coil 63 can be rapidly diffused to the exterior. Consequently, increment of temperature in the inductor 60 is restrained, making it possible to achieve large current flow in the coil 63. Also, because the armoring material 64 forms a magnetic body as a result of containing ferrite powder, a magnetic circuit is in a closed state through the bobbin 64 and the armoring material 64, in other words, a closed magnetic path is formed, with the advantageous effect that a large inductance can be obtained. Hereafter, the inductance is referred to as an L value.

In addition, there is known another conventional inductor in which a solenoid-shaped coil configured to be connected to a commercially available alternating-current power line is imbedded in a magnetic body (for reference, see Japanese Patent Laid-Open No.2002-324630, p 3 of the specification and FIG. 3).

FIG. 15 illustrates an example of the other conventional inductor. The inductor 70 is composed of a solenoid-shaped coreless coil 71 and a resin member 73 encasing the coreless coil 71. Terminal electrodes 72a and 72b configured to connect to the exterior are connected to the coreless coil 71. The resin member 73 comprises epoxy resin and ferrite powder of a predetermined amount contained in the epoxy resin.

Because the inductor 70 structured as mentioned above has increased magnetic permeability μdue to the resin member 73 in which the magnetic powder is contained, there is an advantageous effect that a large L value can be achieved, thereby enhancing the capacity to exclude noise in the power line.

However, the aforementioned conventional inductors have the following problems.

In the former inductor 60, because the armoring material 64 contains ferrite powder, the ferrite powder is attached to and exposed to a surface of the armoring material 64. Therefore, in the case where the inductor 60 is mounted on the circuit board or the like, when inductors are inserted in a part feeder, there is a possibility that the ferrite powder is removed from the surface of the armoring material 64 by the contact between the inductors, or the like.

There is also even a possibility that the ferrite powder is removed from the surface of the armoring material 64 when mounting the inductor on the circuit board, handling the circuit board after the mounting is completed, washing a completed product, washing the circuit board after the mounting is completed, or the like. Furthermore, after the circuit board on which the inductor 60 is mounted is installed in an electronic device, there is also even a possibility that the ferrite powder is removed from the surface of the armoring material 64 when the electronic device is dropped during use or an impact such as vibration or the like is applied to the electronic device.

On the other hand, if the amount of the ferrite powder contained in the armoring material 64 is reduced in consideration of the removal of the ferrite powder, the coil has lower magnetic permeability μ and a small L value resulting in large variation of the L value. Consequently, there is a possibility that an electronic circuit in which the inductor 60 is installed operates unstably or ceases to function.

In addition, because the ferrite powder removed from the armoring material 64 flies loose in the electronic device, if the electronic device is a precision instrument such as an electronic clock, a digital camera or the like, the loose-flying ferrite powder may cause mechanical malfunction in the instrument.

Because the aforementioned phenomena also occur in the latter inductor 70, there is a problem that the inductor 70 has a reduced L value and, in consequence, the noise excluding capacity of the power line is reduced.

### SUMMARY OF THE INVENTION

An object of the present invention is to provide a compact, thinned and inexpensive inductor having a stable characteristic with an unchanging L value even when there is contact during mounting of the inductor or impact during use of an electronic device in which the inductor is installed, a necessary and sufficient L value, high performance and excellent reliability, and a method for producing the inductor.

An inductor according to one embodiment of the present invention includes a coil having a bobbin and a metallic wire wound on the bobbin, ends of the metallic wire electrically connected to terminal electrodes, a first resin containing magnetic powder and disposed on at least one position of a peripheral side surface of the coil, and a second resin sealing at least the first resin. The second resin is nonmagnetic.

The magnetic powder contained in the first resin includes ferrite powder, and also, the bobbin may be made of magnetic material. In one embodiment, opposite two positions of the peripheral side surface are covered by the first resin. In another embodiment, the first resin is disposed on the entire peripheral side surface of the coil.

In addition, a method for producing an inductor according to another embodiment of the present invention includes a process for attaching an adhesive material to a multiple-formed collective substrate including a plurality of sections of substrates each including a pair of terminal electrodes, a process for mounting a plurality of bobbins each disposing in each section of the collective substrate, a process for winding the metallic wire continually on each of the bobbins in each section of the collective substrate to form a collective coil, a process for providing a first resin including magnetic powder and covering at least a part of a peripheral side surface of the coil with a first resin, a process for sealing the coil covered by the first resin member with a second resin member in which a magnetic powder is not contained, to form a collective inductor, and a process for cutting the collective inductor into a plurality of independent inductors.

### BRIEF DESCRIPTION OF THE DRAWINGS

FIG. 1 is a perspective view showing an inductor according to a first embodiment of the present invention.

FIG. 2 is a sectional view taken along line A-A of FIG. 1.

FIG. 3 is a perspective view showing an inductor according to a second embodiment of the present invention.

FIG. 4 is a top plan view showing the inductor according to the second embodiment.

FIG. 5 is a perspective view showing an inductor according to a third embodiment of the present invention.

FIG. 6 is a flowchart showing a process for producing an inductor according to a fourth embodiment of the present invention.

FIG. 7 is a perspective view for explaining a process for producing a collective lead frame in the production method for the inductor according to the present invention.

FIG. 8 is a perspective view for explaining a process for attaching an adhesive material to the collective lead frame in the production method for the inductor according to the present invention.

FIG. 9 is a perspective view for explaining a process for mounting a plurality of bobbins on the collective lead frame in the production method for the inductor according to the present invention.

FIG. 10 is a perspective view for explaining a coil winding process and a terminal treatment process in the production method for the inductor according to the present invention.

FIG. 11A is a perspective view for explaining a process before a magnetic resin is applied to an outer peripheral surface of a coil, in the production method for the inductor according to the present invention.

FIG. 11B is a perspective view for explaining a process after the magnetic resin is applied to the outer peripheral surface of the coil, in the production method for the inductor according to the present invention.

FIG. 12 is a perspective view for explaining a process for forming a collective inductor by sealing the collective lead frame and coils with a resin member, in the production method for the inductor according to the present invention.

FIG. 13A is a perspective view for explaining a process for cutting the collective inductor into a plurality of single inductors, in the production method for the inductor according to the present invention.

FIG. 13B is a perspective view for explaining how the plurality of inductors are completed by the cutting process of the collective inductor, in the production method for the inductor according to the present invention.

FIG. 14 is a sectional view showing one example of a conventional inductor.

FIG. 15 is a sectional view showing another example of a conventional inductor.

### DETAILED DESCRIPTION OF THE PREFERRED EMBODIMENTS

Preferred embodiments of the present invention will be explained in detail hereinafter with reference to the accompanying drawings.

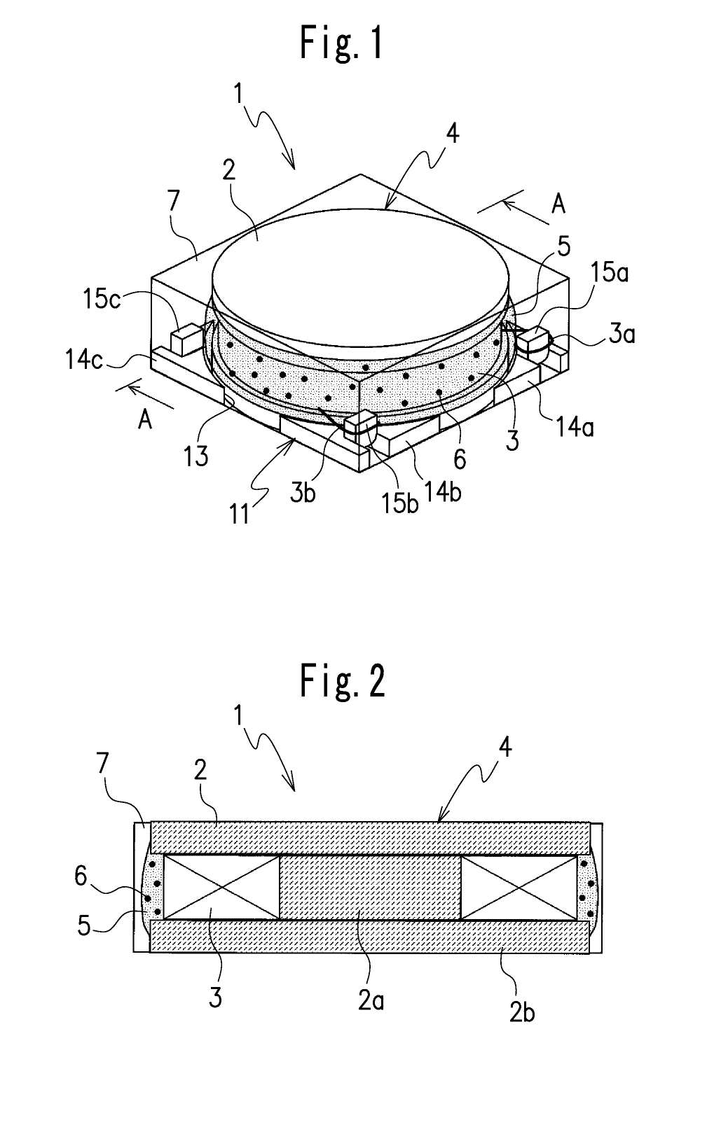

FIGS. 1 and 2 illustrate a structure of an inductor according to a first embodiment of the present invention. The inductor 1 in this embodiment includes a coil 4 which is formed by a bobbin 2 made of a magnetic material such as a ferrite material and a metallic wire 3 wound around a cylindrical winding core 2a of the bobbin 2. The bobbin 2 further includes flange portions 2b provided at opposite ends of the winding core 2a, and each of the flange portions 2b has a diameter larger than that at the winding core 2a (see FIG. 2).

A magnetic resin 5 as a first resin member is applied to an entire peripheral side surface of the coil 4 to cover the metallic wire wound around the winding core 2a. The magnetic resin 5 includes epoxy resin containing magnetic powder 6. As the magnetic powder 6, a mixture of ferrite powder of NiZn-type or MnZn-type and silicon steel, iron, amorphous metal or the like is preferably used. It should be noted that, in FIGS. 1 and 2, the magnetic powder 6 contained in resin is shown schematically as the magnetic resin 5, and because in reality the magnetic powder comprises minute particles, it is not visible.

In this way, the resin achieves a nature of a magnetic material by containing the magnetic powder 6. Covering the peripheral side surface of the coil 4 with the magnetic resin 5 causes formation of a pot core-like closed magnetic path on the coil 4 by the metallic wire wound around the bobbin 2 which is made of the magnetic material, the flange portions 2b and the magnetic resin 5. Consequently, it is possible to increase the magnetic permeability μ of the coil 4 compared with a case where the magnetic resin is not applied and hence increase an L value of the inductor. Here, the L value means an inductance of the inductor.

It should be noted that, it is possible to increase the magnetic permeabilityμ of the coil 4 and increase an L value by increasing an amount of magnetic powder 6 in the resin 5, but it is preferable to decide an appropriate contained amount of the magnetic powder in consideration of workability of application and cost. In addition, as shown in FIG. 2, if the resin 5 containing magnetic powder is disposed between the flange portions 2b of the bobbin 2, a magnetic resistance of the magnetic circuit is lowered and therefore an L value can be efficiently increased.

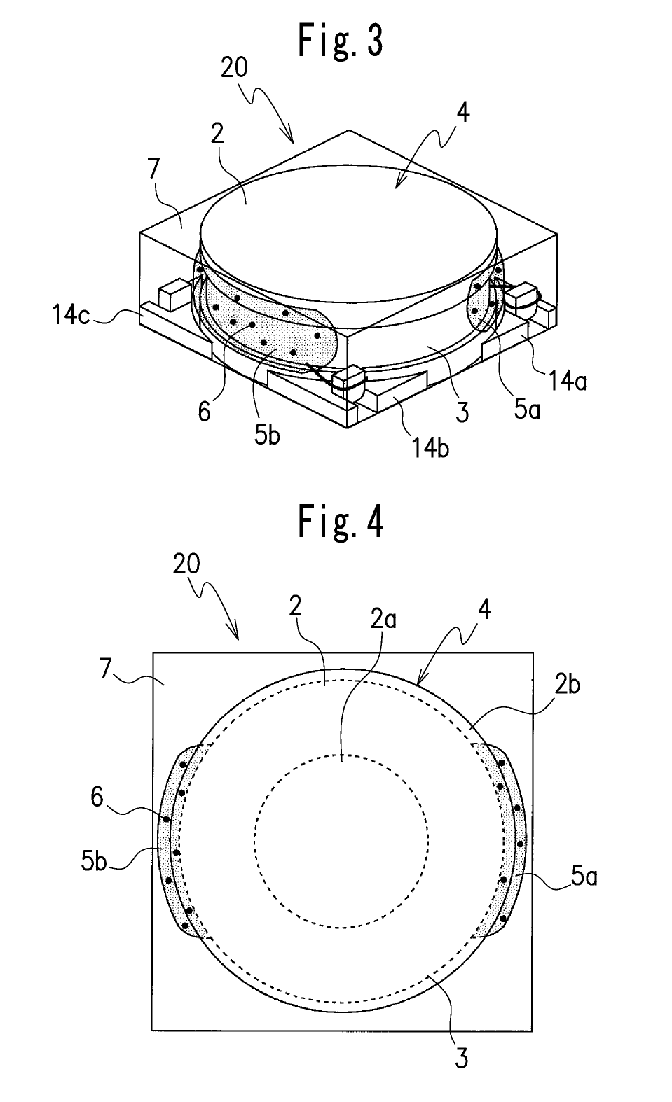

A lead frame 11 as a substrate is disposed at a lower surface of the bobbin 2 (see FIG. 1). The lead frame 11 is made of a metallic material and has at a central portion thereof a circular penetrated hole 13 in which the coil 4 is installed. In addition, the lead frame may be provided with at least two terminal electrodes for electrical connection with the inductor. Here are four comers thereof with four terminal electrodes 14a to 14d for the inductor 1 (see FIGS. 1 and 3).

Note that the terminal electrode 14d is hidden in a rear side of the coil 4 in the drawings. The terminal electrodes 14a to 14d have partially upwardly extending bent portions 15a to 15d, respectively. Winding terminals 3a and 3b of the metallic wire 3 are wound about the bent portions 15a and 15b of the two terminal electrodes 14a and 14b of the terminal electrodes 14a to 14d, respectively and electrically bonded thereto by welding, soldering or the like.

The other two terminal electrodes 14c and 14d are not usually connected to any parts and are used as dummy terminals. Meanwhile, connection positions of the winding terminals 3a and 3b to the terminal electrodes 14a and 14b are not limited and may be arbitrarily set. Moreover, if the inductor 1 is used, for example, as a transformer, the metallic wire 3 is doubly wound and the four winding terminals of the metallic wire 3 may be bonded to their respective terminal electrodes 14a to 14d. Thus, the terminal electrodes 14a to 14d can be connected to a mounting substrate (not shown) or the like to mount the inductor 1, thereby enabling electrical connection to an electronic circuit provided on the mounting substrate.

The terminal electrodes 14a to 14d, the resin 5 containing magnetic powder as a first resin to cover the peripheral side surface of the coil 4 and the lead frame 11 are sealed by a sealing member 7 as a second resin. The second resin 7 is made of resin such as epoxy resin, but, unlike the first resin 5, it does not contain magnetic powder.

In the inductor 1 having the aforementioned structure, because the first resin 5 is sealed by the second resin 7, the magnetic powder 6 contained in the first resin 5 is not exposed outside the inductor 1. Therefore, the magnetic powder 6 does not fall from the first resin even if there is a contact during mounting of the inductor 1, an impact during use of an electronic instrument in which the inductor 1 is installed, or the like, resulting in a stable L value and excellent reliability.

In addition, because the peripheral side surface of the inductor 1 is entirely sealed by the second resin 7, an inductor having good mechanical strength and excellent anti-weatherability can be provided. Furthermore, because the bent portions 15a to 15d of the terminal electrodes 14a to 14d are securely sealed with the sealing member 7, the terminal electrodes 14a to 14d are securely fixed to the sealing member 7. It should be noted that the second resin 7 is shown as a transparent member in FIG. 1 for convenience of explanation, and therefore, the second resin may be colored in black as a product.

FIGS. 3 and 4 illustrate a structure of an inductor according to a second embodiment of the present invention. In the second embodiment, by attaching identical reference numbers to parts identical to those in the first embodiment, some repetition of explanation is omitted.

In FIGS. 3 and 4, reference number 20 shows the inductor according to the second embodiment. The inductor 20 includes the coil 4 formed by winding the metallic wire 3 about the winding core 2a of the bobbin 2 which is made of the magnetic material such as the ferrite material or the like, similarly to the first embodiment.

The first resin in which the magnetic powder 6 is contained are applied to the peripheral side surface of the coil 4, but are partially applied on opposite two positions 5a and 5b of the peripheral side surface of the coil 4 to cover a part of the coil 4, differently from the first embodiment. The first resin may be epoxy resin and contains magnetic powder 6, a mixture of ferrite powder of NiZn-type or MnZn-type and silicon steel, iron, amorphous metal or the like is preferably used, similarly to the first embodiment.

In addition, the terminal electrodes 14a to 14d of the inductor 1, the first resin 5 to cover the peripheral side surface of the coil 4 and an upper surface of the lead frame 11 are sealed by the second resin 7 in which the magnetic powder is not contained, similarly to the first embodiment.

In the inductor 20 having the aforementioned structure, because the first resin disposed at 5a and 5b is sealed by the second resin 7, similarly to the first embodiment, the magnetic powder 6 contained in the first resins 5a and 5b is not exposed outside the inductor 20 and the magnetic powder 6 does not fall from the first resin even if there is a contact during mounting of the inductor 20, an impact during use of an electronic instrument in which the inductor 1 is installed, or the like, resulting in a stable L value and excellent reliability.

In the second embodiment, because the first resin is partially applied at two places 5a and 5b on the peripheral side surface of the coil 4 as shown in FIGS. 3 and 4, the coil 4 is in a state where only a part of the magnetic circuit is closed by the bobbin 2 and the first resin at 5a and 5b. Consequently, because the coil 4 of the inductor 20 has a low magnetic permeability μ, if a size of the coil 4 and the number of winds of the metallic wire 3 are the same as in the inductor 1 in the first embodiment, an inductor having a lower L value can be achieved even with the same resistance.

Moreover, in the inductor 20 in the second embodiment, the first resin is applied at two places 5a and 5b on the peripheral side surface of the coil 4 to face each other. However, the application of the first resin is not limited to the aforementioned arrangement. For example, it is possible to apply the first resin at three places on the peripheral side surface of the coil 4 or the first resin in a narrow area at one place on the outer peripheral surface. That is to say, a range of closing of the magnetic circuit of the coil 4 changes according to a range of application of the first resin on the peripheral side surface of the coil 4, and consequently, the magnetic permeability μ of the coil 4 changes, and thus, it is possible to provide an inductor having any L value without changing a resistance value.

Next, an example of change in L value obtained by an experimental test is described.

Here, if the L value in the case where absolutely no first resin is applied is taken as standard, then in the case where first resin, for example, first resin is applied at one place either 5a or 5b in FIG. 4 on the peripheral side surface of the coil 4, the inductor has an L value increased by about 1.7 times. Moreover, in the case where the first resin (for example, both at 5a and 5b in FIG. 4) is applied at two places on the peripheral side surface of the coil 4, the inductor has an L value increased by about three times. In addition, as shown in the first embodiment, in the case where the first resin 5 is applied on the entire peripheral side surface of the coil 4, the inductor has an L value increased by about 4.5 times.

The inductor according to the present invention makes it possible to change an L value even by changing an amount or kind of the magnetic powder 6 contained in the first resin 5 applied to the peripheral side surface of the coil 4. In this way, because the L value can be changed arbitrarily while maintaining the same resistance, by changing an applied range and an applied amount of the first resin 5 covering the peripheral side surface of the coil 4 and a contained amount of the magnetic powder 6 without changing the size of the coil 4 or number of winds of the metallic wire 3, it is possible to accomplish a series of inductors, easily.

Next, a structure of an inductor according to a third embodiment of the present invention is described with reference to FIG. 5.

In the third embodiment, identical reference numbers are attached to parts identical to those in the first embodiment, so that some repetition of explanation is omitted.

As shown in FIG. 5, the inductor 30 according to the third embodiment includes the coil 4 formed by winding the metallic wire 3 about the winding core 2a of the bobbin 2 which is made of the magnetic material such as ferrite material, similarly to the first embodiment.

The first resin 5 in which the magnetic powder 6 is contained is applied to the peripheral side surface of the coil 4. The first resin 5 covers the entire peripheral side surface of the coil 4, similarly to the first embodiment. Therefore, the coil 4 is in a state where a magnetic circuit is closed by the bobbin 2 and the first resin 5, thereby an inductor having a large L value can be acquired.

It should be noted that the first resin 5 includes epoxy resin as main constituent, and that as the magnetic powder 6 contained in the first resin 5, a mixture of ferrite powder of NiZn-type or MnZn-type or the like and silicon steel, iron, amorphous metal or the like is preferably used, similarly to the first embodiment.

A circuit board 31 as a substrate is disposed on a lower surface of the coil 4 (see FIG. 5). The circuit board 31 is provided at both upper and lower surfaces thereof with printed wirings. Wiring patterns 32a and 32b are provided at two comers on an upper surface of the circuit board 31, respectively, and ends 3a and 3b of the metallic wire 3 are electrically connected to the wiring patterns 32a and 32b by thermal compression bond, soldering or the like. Note that the wiring patterns 32a and 32b are connected to electrodes provided on a lower surface of the circuit board 31 by through-holes (not shown) and to a mounting substrate (not shown) or the like which is configured to mount the inductor 30.

Similarly to the first embodiment, the coil 4, the first resin 5 configured to cover a part of the peripheral side surface of the coil 4 and the wiring patterns 32a, 32b provided on the upper surface of the circuit board 31 are sealed by the second resin 7 as the second resin member in which the magnetic powder is not contained.

In this way, because the first resin 5 is sealed by the second resin 7, the magnetic powder 6 contained in the first resin 5 is not exposed outside the inductor 30. Therefore, the magnetic powder 6 does not fall from the first resin even when there is contact during mounting of the inductor 30, impact during use of an electronic instrument in which the inductor 30 is installed, or the like, resulting in a stable L value and excellent reliability.

It should be noted that in the third embodiment, the first resin 5 is applied to the entire peripheral side surface of the coil 4, but the application of the first resin 5 is not limited to this configuration, for example, the firs resin 5 may be applied to a part of the peripheral side surface of the coil 4, as shown in the second embodiment, so that it is possible to optionally adjust an L value depending on an applied range of the first resin or the like.

As mentioned above, because the inductor according to the present invention has a structure such that the first resin in which the magnetic powder is contained is applied to the peripheral side surface of the coil and the outer surface of the first resin is sealed by the second resin, it is possible to acquire a stable L value without the magnetic powder being removed by the contact during mounting of the coil or impact during use of the inductor. Consequently, it is possible to prevent a malfunction of the inductor or a circuit in which the inductor is installed, and thus provide an inductor having good reliability and impact resistance. In addition, because the magnetic powder does not fly loose from a surface of the inductor, the inductor can be installed safely even in a precision electronic device such as an electronic clock, a digital camera or the like.

Here, because the coil is covered by the first resin, it has a high magnetic permeability μ and it is possible to achieve an inductor having a large L value and high performance even though it is compact and thin.

Furthermore, because an inductor having different L values with the same resistance can easily be produced by changing the applied range of the first resin covering the outer peripheral surface of the coil, the amount of magnetic powder contained in the first resin, or the like, an inexpensive inductor having a series of L values can be provided.

In the aforementioned embodiments of the present invention, the coil 4 includes the bobbin 2 as the core, but the coil 4 is not limited to this structure, a coreless coil having no bobbin may be used. If the coil 4 is a coreless coil, the entire outer surface of the coil 4 may be embedded in the first resin 5 and its peripheral side surface is sealed by the second resin 7.

Next, a method for producing the inductor according to the present invention is described.

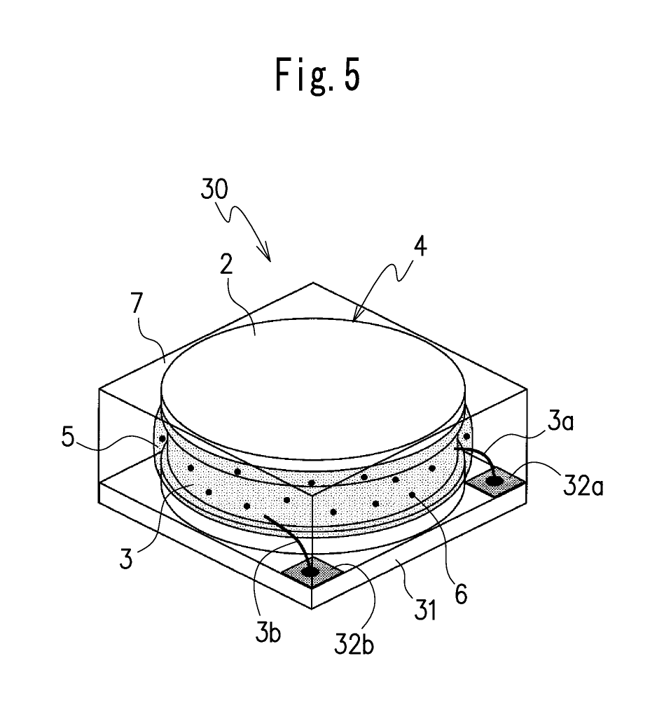

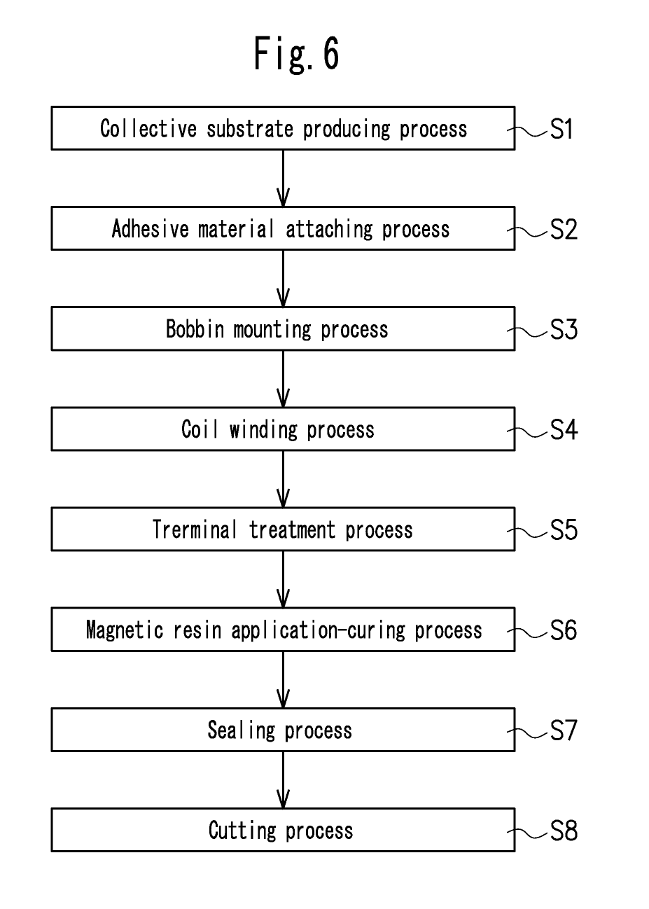

FIG. 6 illustrates a flowchart of processes for producing the inductor according to the present invention. The inductor is produced by way of a collective substrate producing process S1, an adhesive material attaching process S2, a bobbin mounting process S3, a coil winding process S4, a terminal treatment process S5, a magnetic resin as a first resin application-curing process S6, a sealing process S7, and a cutting process S8.

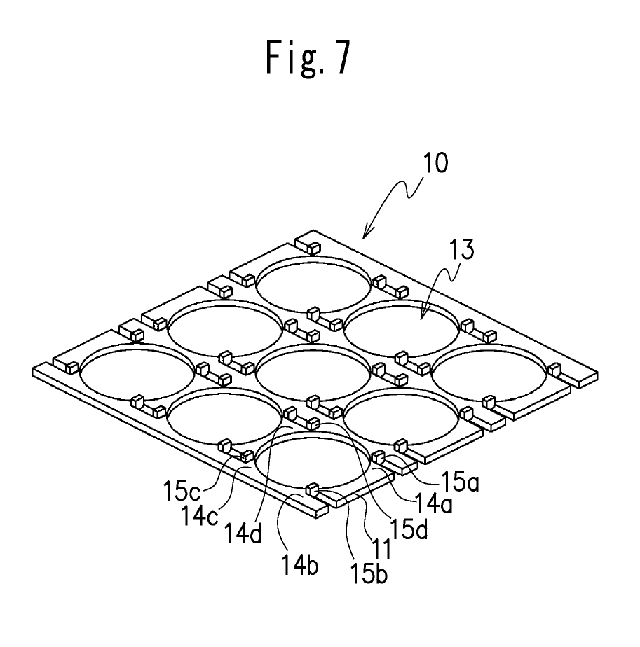

The processes are described hereinafter with reference to FIGS. 7 to 13.

The following explanation about the processes is made with the inductor 1 according to the first embodiment taken as an example.

The collective substrate producing process S1 for producing a collective lead frame as a collective substrate is first described with reference to FIG. 7. In the collective substrate producing process S1, a plurality of penetrated hole 13, bent portions 15a to 15d for terminal electrodes 14a to 14d and so on are formed together on a thin plate made of a metallic material or the like. Through this processing, it is possible to acquire a collective lead frame 10 acting as a multiple-formed collective substrate in which a plurality of substrates or lead frames 11 can be formed together.

It should be noted that the arrangement of the collective lead frame 10 is not limited to the illustrated manner, for example, it may be formed in a long reel-like shape, or it may be a collective lead frame in which a long reel-like collective lead frame is cut into a plurality of parts each of which has a certain length.

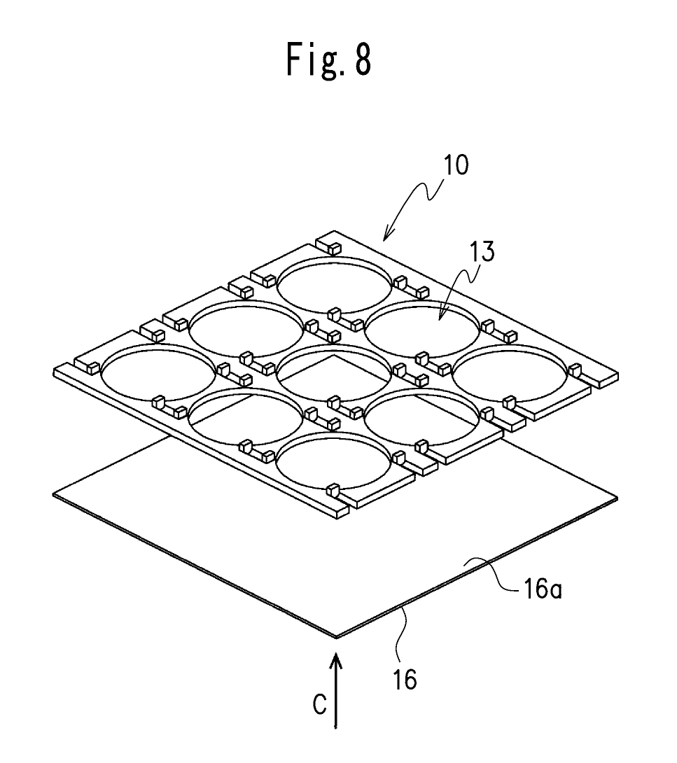

Next, the adhesive material attaching process S2 is described with reference to FIG. 8.

In the process S2, a surface-shaped adhesive tape 16 as the adhesive material is attached to the entire lower surface of the collective lead frame 10 by applying a pressure in a direction of arrow C. By the process, an adhesive surface 16a of the adhesive tape 16 in the plurality of penetrated holes 13 is exposed and the holes 13 are formed in the collective lead frame 10.

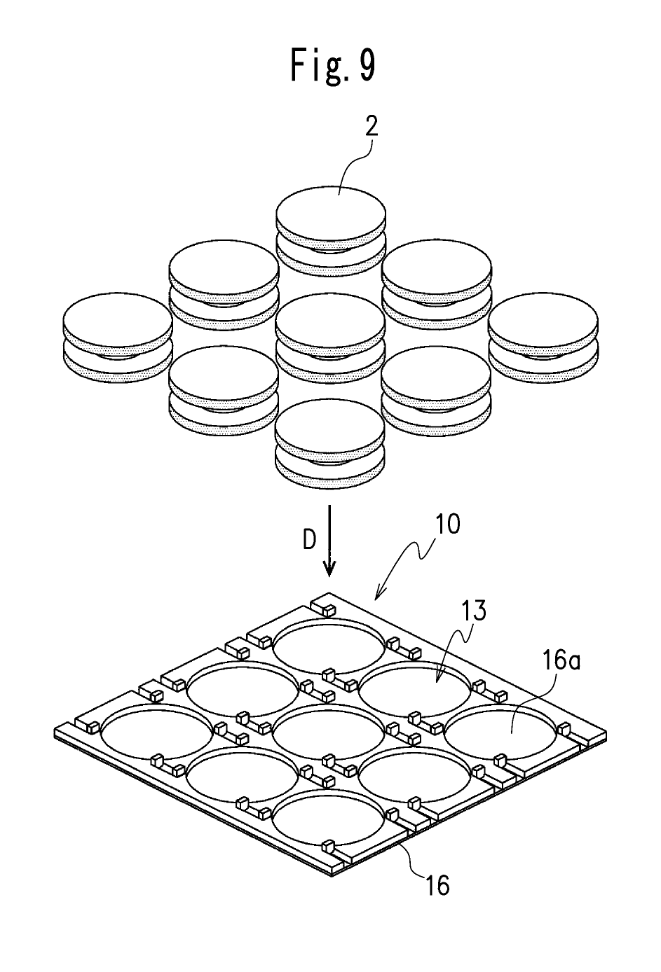

Next, the bobbin mounting process S3 is described with reference to FIG. 9.

In the process S3, a plurality of bobbins 2 are arranged on, for example, a tray (not shown) to correspond to positions of the penetrated hole 13 of the collective lead frame 10, then inserted into the penetrated hole 13 through a process of moving the tray in a direction of arrow D. In other words, because an adhesive surface 16a of the adhesive tape 16 is exposed at a bottom surface of each of the penetrated hole 13, as described above, by pressing the arranged bobbins 2 in the direction of arrow D, each of the plurality of bobbins 2 is fitted in the penetrated hole 13 to be adhered to the adhesive surface 16a and fixed therein.

By setting each penetrated hole 13 to have a diameter slightly less than that of the bobbin 2 and press-fitting the bobbin 2 into the penetrated hole 13, the bobbins 2 can be firmly combined to the collective lead frame 10, and even if the adhesive tape 16 has a weak adhesive force, the bobbins 2 can be prevented from being removed from the penetrated hole 13. In addition, by press-fitting the bobbins 2 into the penetrated hole 13, each of the bobbins 2 may be more accurately positioned on the collective lead frame 10, so that the coil winding process S4 which is the next process can be smoothly be carried out.

Alternatively, by setting the diameter of the penetrated hole 13 to be slightly larger than that of the bobbin 2, each bobbin 2 may be loosely inserted in the penetrated hole 13 so that the bobbin 2 is fixed to the collective lead frame 10 only by way of the adhesive force of the adhesive tape 16. In this case, it is possible to fit the bobbin 2 in the penetrated hole 13 even if the bobbin 2 is not accurately positioned with respect to the penetrated hole 13. Thereby, the tray to arrange the bobbins 2 can to a certain extent be designed roughly to a certain level to simplify the bobbin mounting process S3. Whether the fit of the bobbin 2 in the penetrated hole 13 is to be press-fitting or loose-fitting may be selected depending on product specification or capability of the production processes.

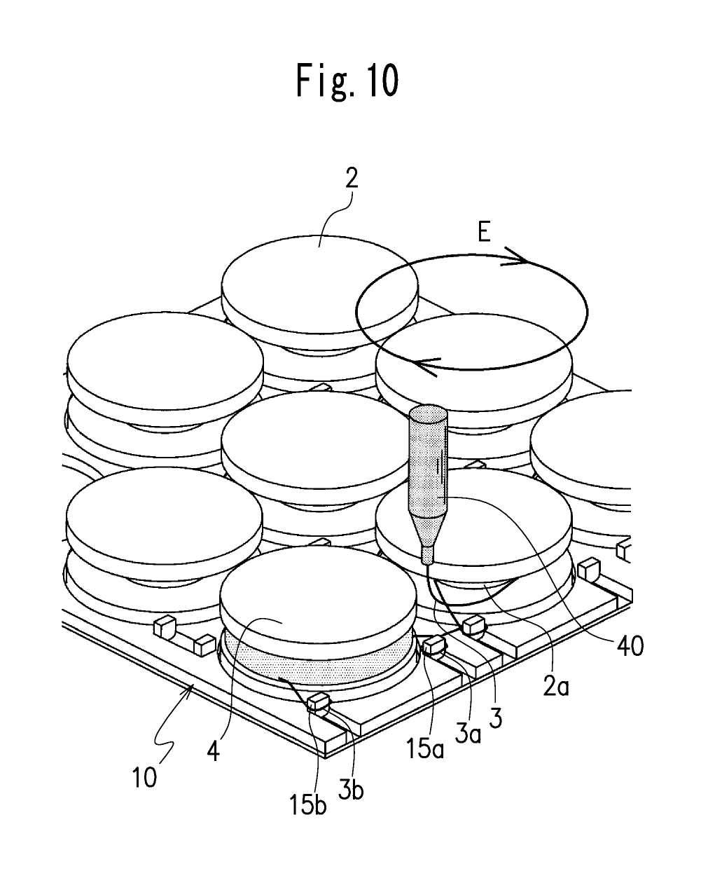

Next, the coil winding process S4 and the terminal treatment process S5 are described with reference to FIG. 10.

In FIG. 10, reference number 40 shows a nozzle of a winding machine (not shown). The nozzle 40 is supported on a rotational shaft (not shown) configured to turn about a central axis of each coil 4. The nozzle 40 is configured to pay out the metallic wire 3 while turning in a direction of arrow E, for example. Thereby, the metallic wire 3 paid out by the nozzle 40 is wound on each of the bobbins 2 mounted on the collective lead frame 10 to form the coil 4.

More specifically, the nozzle 40 is moved in accordance with a program set in the winding machine and the nozzle 40 is configured to move in X-Y direction. The metallic wire 3 is first wound at one end on a bent portion 15b, thereafter wound on the winding core 2a of the bobbin 2 a predetermined number of times, by turning the nozzle 40 in the direction of arrow E, thereafter wound at another end on a bent portion 15a.

Thereafter, the nozzle 40 is moved to the adjacent bobbin 2, the metallic wire 3 paid out by the nozzle 40 is first wound at one end thereof on the corresponding bent portion 15b, then on the winding core 2a of the bobbin 2 a predetermined number of times, and wound at another end thereof on the bent portion 15a. In this way, the nozzle 40 is moved smoothly in accordance with the program over each bobbin 2, and a winding operation of the metallic wire 3 is continuously carried out, so that the winding operations of the metallic wire with respect to the plurality of bobbins 2 arranged on the collective lead frame 10 can be carried out in a short time.

Here, the winding operations of the metallic wire by the nozzle 40 are not limited to the illustrated winding order of the bobbins and may be set in any manner.

After the coil winding process S4 is completed, the terminal treatment process S5 is started. In the terminal treatment process S5, the winding terminals 3a and 3b of the metallic wire 3 are electrically connected to the bent portions 15a and 15b by arc welding, soldering or the like. In this way, the provision of the bent portions 15a and 15b on the lead frame 10 causes the operation of the coil winding process S4 and the terminal treatment process S5 to be simplified and electrical combination of the metallic wire 3 and the terminal electrodes 14a and 14b to be carried out firmly.

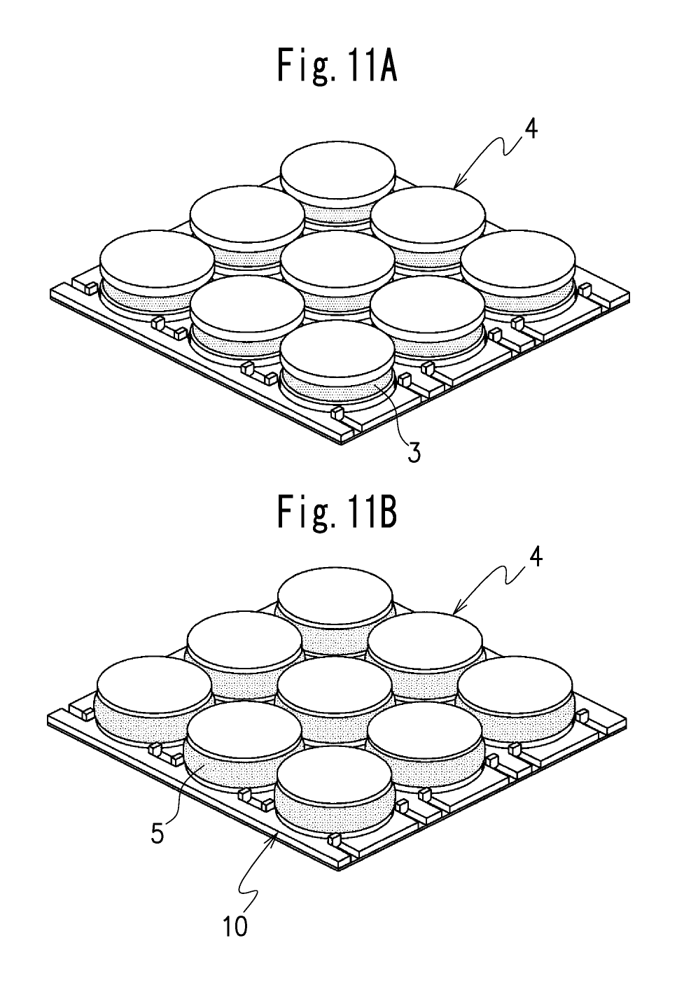

Next, the magnetic resin application-curing process S6 is described with reference to FIGS. 11A and 11B.

As shown in FIG. 11A, the first resin 5 is applied to the peripheral side surface (in other words, an exposed portion of the metallic wire 3) of each of the coils 4 mounted on the collective lead frame 10 in the aforementioned processes, by potting, screen printing or the like, to cover the entire peripheral side surface of each coil 4 with the magnetic resin 5, as shown in FIG. 11B.

It should be noted that the first resin 5 may be applied to not only the entire peripheral side surface of the coil 4, but also a part of the peripheral side surface of the coil 4, that is to say, a range of one place or two places of the peripheral side surface, in accordance with the L value of the inductor to be produced as mentioned above. The amount or kind of the magnetic powder contained in the first resin 5 may be selected according to the L value of the inductor to be produced. Consequently, by adjusting the applied range of the first resin 5, the contained amount of the magnetic powder, or the like, it is possible to produce with wide variety an inductor having different L values.

Furthermore, a curing process for heating the first resin 5 at a predetermined temperature to harden the first resin is carried out after the application of the first resin 5 is completed. Through the curing process, the first resin 5 applied on the peripheral side surface of the coil 4 can be hardened in a short time, and the next process started.

Here, the first resin 5 may be naturally hardened without curing, or hardened in the next sealing process S7.

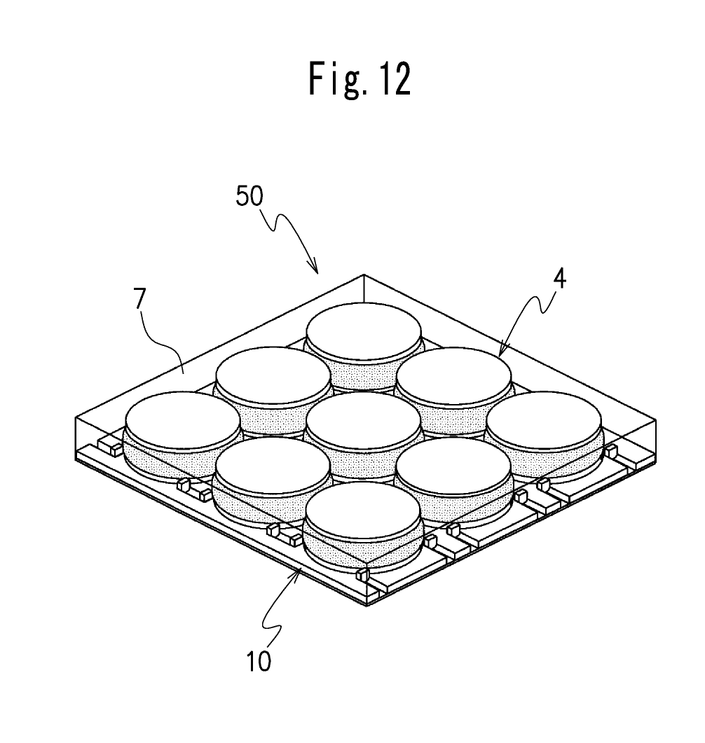

Next, the sealing process S7 is described with reference to FIG. 12.

In the sealing process S7, the collective lead frame 10, each of the coils 4 mounted on the collective lead frame 10 and the first resin 5 applied to the peripheral side surface of each of the coils 4 are sealed with the second resin 7 made of resin such as epoxy resin. The sealing can be carried out by use of an injection forming, a transfer forming, a liquid-state resin-forming or the like. Through the sealing process, a collective inductor 50 in which a plurality of inductors are collected can be completed.

In this way, because the collective inductor 50 is entirely sealed by the second resin 7, the inductor can achieve a good mechanical strength and excellent weatherability. In addition, because the bent portions 15a to 15d (see FIG. 7) formed respectively on the terminal electrodes 14a to 14d of the collective lead frame 10 are bent in a direction embedded in the second resin 7, the terminal electrodes 14a to 14d are firmly fixed to the second resin 7 and difficult to be removed there from. This results in high reliability of the inductor. It should be noted that a lower surface of the collective lead frame 10 is not sealed with the second resin 7. The second resin 7 is preferably configured to seal the coil 4 to an approximately similar level to a height of the coil 4 or a slightly lower level than the height of the coil 4.

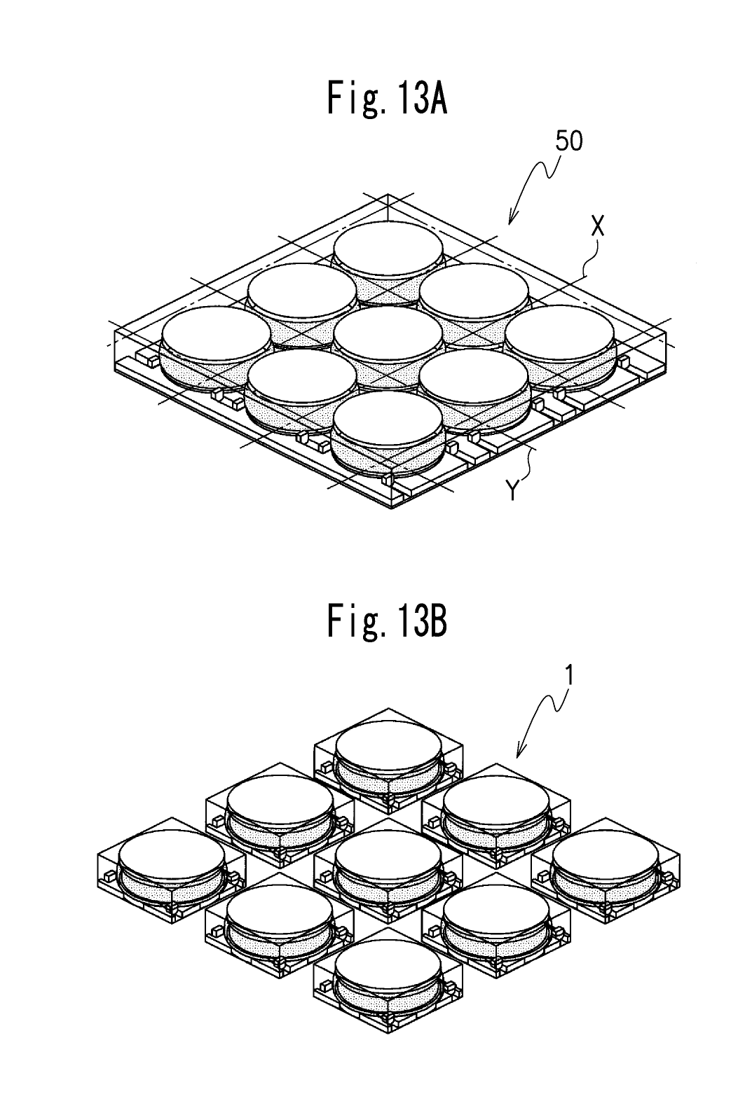

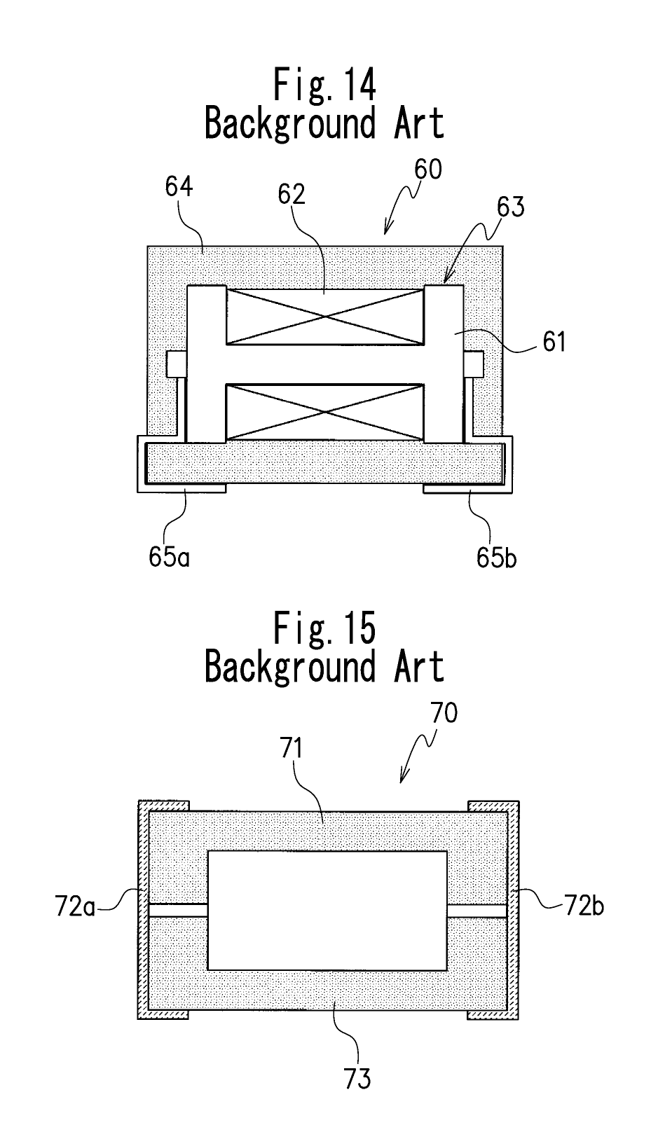

Next, the cutting process S8 in which the collective inductor 50 is cut into a plurality of single inductors is described with reference to FIGS. 13A and 13B.

As shown in FIG. 13A, the completed collective inductor 50 is first cut along cutting lines X and Y by means of a processing method such as dicing, punching or the like. In the case of cutting the collective inductor 50 by the punching process, the collective inductor 50 is preferably formed in such a manner that the coils are arranged on the collective lead frame 10 at wide intervals (the structure is not shown) and that areas (punched areas) adjacent to the cutting lines X and Y are not sealed with the second resin 7.

FIG. 13B illustrates a state where the collective inductor 50 is cut by the cutting process S8 and the plurality of single inductors 1 are completed.

In this way, because the production method of the inductor according to the present invention makes it possible to simultaneously produce together a plurality of inductors by use of the collective lead frame 10, there is an advantageous effect that mass production of a product can be accomplished, or a product with less variation in size or characteristic can be inexpensively produced.

The aforementioned production method has been described with the inductor 1 according to the first embodiment taken as an example. However, the method is not limited to this inductor. For example, the method may be similarly applied to the inductor 30 in which the circuit board 31 is used as a substrate, as shown in the third embodiment.

As mentioned above, in the production method of the inductor according to the present invention, because each of the coils arranged on the collective substrate is covered by magnetic resin and the coils covered by the first resin are sealed together by the second resin, the magnetic powder contained in the first resin does not fall from the coil by contact during mounting of the coils on the collective substrate or impact during use of the inductor or the like, so that an inductor having a stable L value and excellent reliability can efficiently be produced in large numbers.

In addition, the production method according to the present invention makes it possible to produce in batches an inductor having high performance and a large L value.

Furthermore, according to the production method, inductors having the same resistance, but different L values can easily be produced by changing the applied range or applied amount of the first resin configured to cover the peripheral side surface of the coil, and the kind or amount of magnetic powder contained in the first resin.

In the aforementioned embodiments, the inductor in which the single coil is mounted has been described. However, the present invention need not be limited to this manner, and may be applied to multi-inductors in which a plurality of coils are mounted, by optionally changing a shape of the lead frame.

The present invention need not be limited to an inductor and may be applied, for example, to hybrid SMD (surface-mounted device) parts in which the other parts such as an IC chip or the like are mounted on a lead frame together with the coil, or the like.

Although the preferred embodiments of the present invention have been described, it should be understood that the present invention is not limited to these embodiments, and that various modifications and changes can be made to the embodiments.

What is claimed is:

1. An inductor, comprising:
a coil including a bobbin and a metallic wire wound on the bobbin;
ends of the metallic wire electrically connected to terminal electrodes;
a first resin containing magnetic powder and disposed on at least one position of a peripheral side surface of the coil; and
a second resin sealing at least the first resin.

2. The inductor according to claim 1,
wherein the magnetic powder includes ferrite powder.

3. The inductor according to claim 1,
wherein the bobbin is made of a magnetic material.

4. The inductor according to claim 1,
wherein opposite two positions of the peripheral side surface of the coil are covered by the first resin.

5 . The inductor according to claim 1,
wherein the terminal electrodes are provided on a lead frame and the coil is disposed in the lead frame.

6. The inductor according to claim 1,
wherein the terminal electrodes are provided on a circuit board and the coil is disposed in the circuit board.

7. The inductor according to claim 1,
wherein the first resin is disposed around the peripheral side surface of the coil.

8. The inductor according to claim 1,
wherein the second resin is nonmagnetic.

9. The inductor according to claim 1,
wherein the first resin is provided on the wound metallic wire.

10. The inductor according to claim 1,
wherein the second resin constitutes a substantially square shape in top-plan view and seals at least the first resin.

11. A method for producing an inductor according to claim 1, the method comprising:
a process for attaching an adhesive material to a multiple-formed collective substrate including a plurality of sections of substrates each including a pair of terminal electrodes;
a process for mounting a plurality of bobbins each disposing in each section of the collective substrate;
a process for winding the metallic wire continually on each of the bobbins in each section of the collective substrate to form a collective coil;
a process for providing a first resin including magnetic powder and covering at least a part of a peripheral side surface of the coil with a first resin;
a process for sealing the coil covered by the first resin member with a second resin member in which a magnetic powder is not contained, to form a collective inductor; and
a process for cutting the collective inductor into a plurality of independent inductors.
